(19) United States
(12) Patent Application Publication
(10) Pub. No.: US 2005/0129178 A1
(43) Pub. Date: Jun. 16, 2005

(54) Detector using carbon nanotube material as cold cathode for synthetic radiation source

(76) Inventor: John W. Pettit, Rockville, MD (US)

Correspondence Address: BLANK ROME LLP, 600 NEW HAMPSHIRE AVENUE, N.W., WASHINGTON, DC, 20037, US

(21) Appl. No.: 10/735,707

(22) Filed: Dec. 16, 2003

(51) Int. Cl. H01J 35/00; H01J 35/22; H01J 35/32

(52) U.S. Cl. 378/122

(57) ABSTRACT

A synthetic radiation source uses a carbon nanotube material as a cold cathode for generation of x-rays. The synthetic radiation source has permits the use of solid-state detectors, improved calibration for detector current leakage, and phase locked detection. The source can be used in numerous areas, such as the detection of thickness and mass per unit area of cigarette paper.

### FIELD OF THE INVENTION

The present invention is directed to a synthetic (i.e., non-radioisotope-based) radiation source and is further directed to various techniques for non-contact measurement of paper, plastic film, tobacco, food, explosives, polymer fiber and coating characteristics and the like using such a source.

### DESCRIPTION OF RELATED ART

Non-contact weight measurement using radiation as a means for probing the weight, thickness or density of the material being measured has been employed in industry for many years. The interaction mechanisms of radiation with material are fairly well understood, and the weights of various substances have been measured in industrial settings using these principles for over thirty years.

There are various sources of radiation that can be used to make these types of measurements generally. A quick survey would include radioisotope sources emitting gamma rays, X-rays and particles such as beta particles, microwave sources, optical sources, infrared sources and radio-frequency sources. All of these types of radiation can be thought of as falling into one of two main categories of radiation based on the energy of the basic particle or packet of radiation called the photon. These two categories are termed ionizing and non-ionizing radiation. Ionizing radiation is radiation that has sufficient energy in an individual particle or photon to knock a bound electron from the atom within the material through which it is passing and create an electron-ion pair within the material. This energy is roughly 30 electron volts or more per photon or particle in air or most elements. An electron volt is a unit of energy often used in connection with the characterization or radiation. It is the amount of energy imparted to an electron when it is accelerated through one volt of electrical potential.

Of the radiation types given above, the radioisotope sources almost always give off ionizing radiation, whereas the microwave, infrared, radio frequency and optical are all non-ionizing, except in perhaps a few very rare cases. Ionizing radiation interacts with material chiefly through the excitation of atomic levels, through direct atomic interactions and nuclear interactions. Therefore, ionizing radiation interacts in a manner that is proportional to the number of atoms present in a material and this is directly related to the weight of the material under measurement.

Non-ionizing radiation can interact through a variety of other mechanisms, including wavelike interactions such as reflection, refraction and resonant absorption and scattering at the molecular level. These mechanisms vary in strength and percent effect by huge amounts depending on numerous properties or states of the material. Surface reflectivity can change dramatically in ways that are totally unrelated to the material's weight. Resonant absorption at the molecular level can change wildly with minuscule changes in material composition, and refraction properties will change with changes in material characteristics and boundary and interface conditions. The main point in all of this is that the amount of measured radiation after interacting with material is not dependably related to the material's weight when one uses non-ionizing radiation.

Thus, only through the use of ionizing radiation can a measurement be made that will be dependably related to the weight of a material. The other types of radiation are useful for a host of other uses, but when one wants a weight measurement, only ionizing radiation will give consistent results that will be accurate for changes in material properties, such as composition changes, density changes, surface conditions, and so forth.

As mentioned above, ionizing radiation is generated in the vast majority of industrial applications through the use of radioisotope sources. These sources are relatively inexpensive, small and light-weight, and in many applications long lasting. They can emit a stable output of radiation that can be used as a source for precision measurements. Over the years, vendors of these sources have engineered source capsules of radioisotopes such as Strontium-90, Krypton-85, Americium-241 and others that have found widespread use in industrial weight and density measurements.

However, some of these properties, in particular the long lifetime and the ionizing nature of the radiation, also create health and safety issues for humans that have prompted the establishment of numerous laws and regulations and state and federal agencies to regulate the use of these sources. People are also becoming increasingly aware of the health and safety effects of these sources and there is a movement away from the use of these sources.

The rules governing the use, sale, shipment and transfer of instruments containing these sources are complex. Since these sources emit continuously with no way to “turn them off,” they represent a continuous hazard to people. The radiation is invisible and cannot be discerned, so people can expose themselves to harmful levels of radiation without knowing that they have done so. The radioisotope material itself may leak out of the capsule and cause contamination problems. Therefore, a set of rules, which comprise inventory and accountability of these sources, leak testing, shutter testing and numerous other requirements, has been implemented by government agencies. Audits, inspections and regular check and updates to safety programs are typically required to use or possess these radioisotope sources. The expense of having trained personnel on hand to implement and oversee these regulations and overall complying with the numerous regulations represents a significant cost and overhead expense for industry in order to use these sources.

In another field of endeavor, carbon nanotubes have attracted attention. One of the main attributes of carbon nanotubes that has been identified is their excellent field emission properties, in which they give off a copious amount of electrons under and electric field. This property has created excitement and significant investment into carbon nanotubes for lighting, signs and other related things. Numerous venture capital funds, business organizations and companies are moving into this field with much enthusiasm for anticipated products and applications.

Thus, a new generation of x-ray tube can be fashioned from these nanotubes, since the first step in the design of an x-ray tube is to generate free electrons. These electrons are then accelerated in a vacuum by the electric field created by a high voltage, ranging from a thousand volts to several hundred thousand volts. These accelerated electrons then hit a target and stop suddenly, giving off x-rays through a process termed Bremsstrahlung, which is German for “braking radiation.”

Conventional x-ray tubes are not used much for gauges, and some companies that do use them are pushing to move their designs to radiation based designs. The reason for this is that conventional x-ray tubes use a heated filament to generate the electrons through thermionic emission. The filament is heated by means of a current, typically, or sometimes an adjacent heater element, so that the electrons have enough kinetic energy to escape the bonds of the solid, the work function energy, and become liberated. The result of this is the generation of electrons to make an x-ray tube, but considerable waste heat is generated, and the process is unstable and hard to control, which is a big problem with gauging applications. Typical conventional x-ray tubes need to warmed up, go through a stabilization process, be pretreated in a process often termed “seasoning”, be actively cooled and numerous other things in order to achieve a stable output of x-rays. People who are involved with conventional x-ray tubes for gauging applications constantly lament the need for these procedures and limitations. It is often common to find that an x-ray tube based gauge has an external mechanical shutter to shield the x-rays when the tube is not in use. The tube is not simply turned off when not in use because of this stability issue, since if the tube were turned off and turned back on,it would have to be stabilized again in a time consuming manner.

Field emission is a type of “cold cathode,” where electrons come off without the use of heat. The electric field gradient cause by a few hundred volts is enough to cause plenty of electrons to flow out of the nanotubes.

The general concept is known in the art. A research group in North Carolina published last summer a good research article about an x-ray tube using carbon nanotubes, and a company named ANI now sells carbon nanotube based cathodes and discloses an x-ray tube based on them. A company named Oxford Instruments X-ray technology group in Scotts Valley, Calif. has such an x-ray tube on the market now, called the Eclipse. They have incorporated this into a hand held fluorescent analyzer called their Horizon product, which is aimed at elemental analysis, such as determining the amount of lead in paint.

### SUMMARY OF THE INVENTION

It will be readily apparent from the above that a need exists in the art for broader practical applications of synthetic radiation sources using carbon nanotube materials. It is therefore a primary object of the invention to provide such practical applications.

Being completely electronic in nature, this new “synthetic radiation source” can be turned off and will emit no radiation in the off state. Therefore, there will be no potential harm to people if the source is lost or stolen or if it is broken or corrupted, since there is no radioisotope to leak out. There is no lingering or residual radiation when the source is turned off or power is removed from the source. Therefore, most of the regulatory issues have been removed or circumvented. There are no inventory requirements, no leak tests, no shutter and no possibility of contamination. There is also no special shipment requirements with respect to declaring a “dangerous goods shipment” with associated labels and packaging requirements. The source is not generated from byproduct of nuclear materials, so it is not even regulated by the US Nuclear Regulatory Commission or the various Agreement State Agencies under the Atomic Energy Act.

The source will emit potentially harmful ionizing radiation when it is turned on, so the instrument that incorporates this synthetic radiation source will in many applications be designed to shield personnel from the radiation when the instrument is in use. Safety interlocks will be incorporated such that the synthetic radiation source will automatically turn off if the instrument is opened or in any way tampered with.

One instrument designed and developed utilizing the synthetic radiation source will have the objective of measuring the basis weight of cigarette paper, which has bands of material, presently consisting of glue, placed on it. The instrument will have the capability of measuring 8,000 rods per minute with 2 bands on each rod. The bands are nominally 1 milligram per every 5 millimeter by 23 millimeter band, which computes to roughly 8 grams per square meter (GSM). The paper nominal basis weight is 25 to 50 GSM and the measurement precision goal shall be 5%.

The synthetic radiation source has definite advantages with respect to attainable measurement performance in addition to its inherent safety features. The synthetic radiation source will allow measurements to be made at a much faster rate than is possible with radioisotope sources. In fact as much as several orders of magnitude will likely be achieved with respect to measurement response time over radioisotope sources. This will permit rods to be measured at production rates of 8,000 rods per minute, in the tobacco industry for example, with a measurement capability that is not speed dependent or production rate limited.

Radiation based measurements need to detect a certain number of particles or photons to achieve a measurement of a given precision. The actual amount needed is determined by several factors. These include the percent effect in terms of change in count rate for a given change in rod weight, the efficiency of the detectors that are used to detect the radiation, and the rate at which the source emits radiation, which is termed the source activity. The assignee of the present application has already invented and pioneered the solid state detectors that maximize detection efficiency over the analog ionization chambers used by other manufacturers. So, the speed limitation comes down to the rate at which particles are produced by the source. Again there is a tradeoff based on cost, size, self absorption, but, mostly, safety and regulatory concerns with respect to how large of a radioisotope source that can be employed. Radiation based systems currently used for rod weight determination use a 25 millicurie Strontium-90 radioisotope source. This is about as large a source as one can get along with and still be able to meet regulatory guidelines and the practicality of encapsulating the source and so forth.

The synthetic radiation source in one embodiment will have an equivalent source activity of over 1 Curie when it is turned on, which is 40 times greater than the 25 millicurie radioisotope source presently employed. Second, electronic control over the synthetic source allows for process gain enhancement techniques to be used which further improve the signal to noise ratio of the measurement by another order of magnitude or greater.

The result is that the synthetic radiation source, along with solid-state detectors and control over the source output to permit signal processing gain techniques, will result in the ability to make measurements of many types of materials at high production rates without being production speed limited.

The instrument will come complete with feedback controls and input/output needed to control the production machinery and an operator display/interface. The physical size of the instrument's measurement head can be designed to fit into existing production machinery space requirements, e.g., roughly 8″ by 8″ by 3″ or 4″ by 6″ by 2″.

The synthetic radiation source has an exit window where the radiation emits. It will be powered by conventional 5V to 24V DC electrical power source. This synthetic radiation source will be one of the main components of an overall measurement head which further comprises the solid-state detectors, electronics and mechanical parts which hold/guide the paper or other material being measured, hold and position the radiation source and detectors and provide physical containment and shielding.

The carbon nanotube based x-ray tube is a viable and indeed superior measurement instrument for weight, thickness, and density applications. There are numerous applications and methods by which the unique properties of this carbon nanotube based x-ray tube would enable applications that could not be done with conventional x-ray tubes.

The main technical advantages of a carbon nanotube based x-ray tube for weight measurement will be summarized. First, as already mentioned, stability of the output of x-rays is a paramount requirement. Without this, the measurement would drift unacceptably. The nanotube based x-ray tubes are very stable, can be turned on and off at will with no warm-up or stabilization and generate very little waste heat. They are also very small and compact, allowing them to be designed into most instruments.

There are two major attributes that make these carbon nanotube based x-ray tubes superior for weight measurement, and as far as the applicant is aware, no one else has disclosed this advantage or method of use. First, since the electron emission process from carbon nanotubes is essentially instantaneous and is controlled by a simple voltage, the output of the tube can be modulated, or keyed on and off so as to create a locking signal that can be used for phase locked detection. This is an enormous advantage, since phase locked detection is used extensively in radar and sonar and many other fields to enhance the signal to noise ratio of a measurement by many orders of magnitude. This is needed in weight measurements, since the detectors, especially solid-state detectors employed in analog mode, drift significantly as a result of their high leakage current. The tube can either be turned off for a very brief amount of time so that the detector's leakage current can be measured, or a modulation can be placed on the x-ray beam for phase locked detection as just described. Solid-state detectors can be operated in the digital, or pulse counting mode, but this mode requires a particle energy of sufficient strength so that single particles can be detected. Soft x-rays are not detectable in counting or digital mode without elaborate detector cooling to reduce leakage current, small detector size, which limits counting efficiency and the resultant long counting periods, which slows down response time of the instrument.

The electrons liberated by the nanotube cold cathode can be accelerated by means of magnetic induction, such as in the betatron, invented by Kerst in the 1930's, and used as the principle for the very first particle accelerators or “atom smashers.” Thus, the present claimed invention can implement a miniature or “pocket betatron” that would accelerate electrons to from 5 thousand volts to a few hundred thousand volts or even a million volts in some applications. The beauty of the betatron principle is that there is no high voltage needed to be generated, as the acceleration is done through magnetic induction, the same principle as an electronic transformer.

Electrons are first generated by the nanotube cold cathode and accelerated in a straight line by a small voltage of a few hundred or a few thousand volts. Then the electrons enter a region of magnetic field, which makes them travel in a circle, due to the Lorentz force qv×B on them. Now the magnetic filed is increased by a prescribed amount and the changing magnetic flux within the circular orbit creates an induction field, dB/dt, that causes the electrons to gain a certain amount of voltage on each trip around the circular orbit. Since the electrons are going quite fast, they gain energy very rapidly, even though the amount of energy per trip around the orbit may be small. Therefore, it is no problem at all to make a betatron device with a cold cathode comprised of nanotubes that produces electrons of several hundred thousand or even a million volts, which then hit the target to produce x-rays.

While the betatron principle is well known, its application to the nanotube-based electron source of the present invention is novel. The betatron is an atom smasher that has not been used for many years in fundamental nuclear research because the energy it can attain is limited and nuclear research went way beyond the betatron capability 40 years ago. The limit for the betatron is that the electrons traveling in an orbit will start to emit radiation due to the acceleration and this radiation increases with electron energy until any further increase of electron energy just produces more radiation and the limit is reached.

The present invention poses no such limits to the application of the principle described above. In many applications, conventional high voltage supplies are used, since those applications typically require only about 30,000 volts.

For many weight measurement applications, there is a need to get down to very small amounts of weight determination, on the order of one gram per square meter (GSM) or less, in a short amount of time, sometimes within a fraction of a millisecond. This requires the use of “soft” x-rays so that a large percent absorption effect is realized. Soft x-rays are produced by lowering the accelerating voltage about five to ten kilovolts. In this energy range, the x-rays are absorbed more readily and a small amount of weight change produces a larger change in the x-rays transmitted, and thus a bigger change in the detector signal, than do more energetic, or “harder” x-rays. The problem here is that the signal in the detector is also very small and may even be beneath the noise floor. This is especially true when fast response times are needed, where large detector bandwidth opens up the noise window, as is well known, and the signal to noise ratio goes down considerably. The ability to employ phase locked detection techniques solves this problem and opens up numerous applications.

For instance, the weight of cigarette paper is about 25 GSM, and the fire retardant coating placed on the paper is about 1 GSM. This application has performance requirements as described above. Another application is to measure dust in the air to meet new workplace environmental regulations. Air is pulled through a filter paper with weight of about 25 GSM and the dust trapped in the filter paper weighs about 1 GSM, so a similar performance requirement is needed here.

This present disclosure relates to new methods to measure the weight of materials using radiation from a new type of radiation emission device. The measurement of the weight of materials has applications in many areas. For many years the weight of materials has been measured by use of ionizing radiation from radioisotope sources. These sources are considered dangerous and there are many rules governing their use and most people want to avoid these sources today. Therefore, a large need exists to perform the same or similar measurement with a source of radiation that is not radioactive, but has the same properties that would allow these measurements to be made. If the source of the radiation were not radioactive, then the great majority of the various laws governing the use of radioisotopes would not apply to this type of device.

The following are projected uses of the present claimed invention, although those skilled in the art who have reviewed the present disclosure will realize that other uses are possible:

1. Industrial weight and thickness measurements, both on-line and off-line, as well as hand held and fixed applications. Included are basis weight (mass per unit area), inferred thickness, density and properties related to these characteristics.

2. Cigarette rod weight determination.

3. Cigarette paper weight determination and the determination of bands placed on the cigarette paper.

4. Aircraft ice detector

5. Dust, dirt, pollen, toxins and other airborne material measurement.

6. Food weight, pouch weight and weight of powders, chemicals, bulk products.

7. Weight of small parts and objects, particularly in high speed, online applications where conventional check weighing machines are not fast or sensitive enough.

8. Detection of objects within boxes or cartons or other enclosures, such as in packaged food, pharmaceutical and other manufacturing processes.

9. Inspection devices, such as counter-terrorism, smuggling, or hiding objects or materials behind walls or enclosures, in car compartments, inside automobile tires and other places intended to conceal the objects or material.

10. The measurement of coatings, laminates, paint, galvanized coatings and adhesives in both on-line, fixed mounted or hand held applications.

11. x-ray imaging applications, including Compton backscatter imaging, to visualize and detect hidden objects, particularly useful in explosives detection, undersea mine detection, antipersonnel mine detection or detection of any object with an atomic number or mass difference from its surroundings.

The physical principle upon which these measurements rely when photons are employed is either the Compton effect for the scattering of photons, or the photo-electric effect for the absorption of photons. The two main operating modes are either transmission geometry or scatter geometry. In transmission geometry, a source of radiation and a detector of radiation are placed on either side of a material to be measured. In backscatter geometry, a source of radiation and detector(s) of the radiation do not have a straight line of sight, but rather rely on the material to be measured to scatter some of the radiation into the detector(s) in order to make a measurement.

The radiation is electronically produced by several techniques. In the first class of devices, electrons are accelerated in a vacuum and either exit the vacuum through a window to produce a beam of energetic electrons with which to make a measurement. Alternatively, the electrons are directed towards a target in order to produce x-rays which then exit the device through a window to make a measurement.

In conventional x-ray equipment, a filament is heated until it emits electrons via thermionic emission, or a finely pointed cathode, termed a cold cathode, emits electrons through field emission caused by a large electric field. Both techniques have severe limitations. In conventional x-ray equipment using thermionic emission from a heated filament, the filament's temperature must be stabilized, the power required to achieve the desired emission is high, the output drifts substantially, and the output cannot be controlled, turned on and off at will, or modulated. In conventional cold cathode field emission, the sharply pointed cathode must be very sharply pointed to produce field emission due to the high electric field gradient caused by a point. This point is so small and fragile, that it is easily destroyed by oppositely charged ions in the vacuum that are attracted to the cathode and the lifetime is severely limited. Usually, devices of this type are fitted with an access port through which the cold cathode can be replaced. This means releasing the vacuum, replacing the cold cathode and then thoroughly cleaning the inside of the device before restoring the vacuum. This can only be accommodated in research or elaborate instruments at a very high cost.

The acceleration of the electrons can be through the use of high voltage, which is by far the most common means, or by magnetic induction, as in the betatron. In the betatron, an increasing magnetic field induces, via Faraday Induction, a voltage around a closed path in which electrons orbit in a vacuum. The electrons gain energy each time they make a trip around the path and the electrons are also kept in a circular path by the magnetic field. The orbiting electrons resemble the “secondary” in a conventional electronic transformer.

An important process in this new type of “synthetic radiation source” is the first step in which the electrons to be accelerated are generated. New means to generate electrons have been disclosed. These include field emission from carbon nanotubes (References: ANI, Oxford Instruments, Eclipse data sheet, Horizon data sheet), laser activated emission by heating an electron emissive target with a high power laser diode (References: Photoelectron Corporation's Laser-X), and ultra small and thereby low thermal mass filaments for therm-ionic emission of electrons (Reference: Moxtex, Inc. miniature x-ray tube).

X-ray tubes based on these principles have been disclosed by others. Several products are now on the market or have been proposed. The most prevalent application is for x-ray fluorescence instruments. Medical radiography, transmission mode (not backscatter mode) imaging, and analytic instrument have been disclosed or proposed. Nobody has disclosed the use of these new radiation sources for weight measurement, backscatter mode imaging and object detection.

These new radiation sources disclosed herein are small, light weight, relatively inexpensive, low power and have other attributes that make them uniquely useful for weight measurement. Because of their small size and low power, they can be designed into equipment of a size and style that is typically used in on-line industrial measurement applications, or into handheld or portable instruments. Low power makes them operable with a battery and allows for stable operation and use without complicated thermal engineering to remove internally generated heat. Some key methods to enhance their usefulness are:
Selection of the optimum voltage to enhance the measurement effect desired. The absorption or scattering of radiation is heavily dependent on the energy of the photon, and this is determined by the accelerating voltage. For thin or low weight materials being measured, a low voltage has advantages in order to achieve a good percent absorption effect.
Setting the output beam current to desired levels, or modulating the output current, is a very desirable trait of these new devices that can be used to an advantage to increase signal to noise level, check for leakage current or other drifts in the detectors, to match the received x-ray signal for a given measurement scenario to the optimum detector characteristics, or make other corrections. Conventional x-ray equipment cannot be operated in this manner and must usually be kept on continually in order to avoid drifts and instabilities and startup procedures. Placing a modulation on the x-ray output that is controlled by an external modulation source is very useful for implementing phase locked detection methods, which are used extensively in radar and sonar applications. These techniques cannot be utilized with conventional x-ray equipment and they have not been disclosed by others in connection with these new radiation sources.

Of particular interest is the use of these new radiation sources with solid-state detectors in order to achieve completely solid-state instruments, instead of relying on the old technology ion chamber or scintillation detectors. Solid-state detectors, such as Silicon PIN diodes and CdZnTe wafers are severely affected by drifts in their leakage current, which causes their output to drift in a manner that cannot be discerned from a weight change in the material being measured. This is a critical limitation that has kept people from using these otherwise very desirable detectors in instrument design. What has not been disclosed by others is that the new radiation sources have attributes that allow this critical limitation in solid-state detectors to be overcome. By being able to turn off the radiation source for a very short period of time that does not affect the measurement performance, the detector's leakage current can be measured and corrected for. These new radiation sources can be turned completely off and turned back on again without drifts and instabilities encountered with conventional x-ray equipment. Additionally, by placing a modulation signal on the radiation source, a capability unique to these new sources, the phase locked detection and other signal processing algorithms may be enabled to overcome detector drift and other deleterious effects, such as amplifier gain drifts. With the use of modulation techniques, the very “soft” radiation produced by low voltage levels can be detected over the background noise. The has particular advantage in low voltage applications such as aircraft ice detection, paper weight detection, bands on cigarette paper, very light weight coatings, dirt and dust detection in the air, and so forth.

A new generation rod weight measurement instrument has been created that incorporates solid-state detectors in a compact measurement head along with the new synthetic radiation source and an embedded high performance microcomputer. Performance meets or exceeds existing sensors with respect to all measurement criteria, including speed, accuracy and stability. Because of the nature of the radiation produced by this synthetic source, the linearity of the response is significantly better than that for radioisotope based instruments. The size, form factor and style of output have been designed to be compatible with existing instruments, so this new instrument may be used as a direct replacement for existing units.

Being completely electronic in nature, this new synthetic radiation source will emit no radiation when turned off. Therefore, there will be no potential harm to people if the source is lost or stolen or if it is broken or corrupted, since there is no radioisotope involved. There is no lingering or residual radiation when the source is turned off or power is removed from the source. Therefore, the reasons for the vast majority of the regulatory issues with radioisotope sources do not exist. There are no inventory requirements, no leak tests, no radiation shutter and no possibility of contamination. There are also no special shipment requirements with respect to declaring a “dangerous goods shipment” with associated labels and packaging requirements. The source is not even regulated by the US Nuclear Regulatory Commission under the Atomic Energy Act.

The source will emit ionizing radiation when it is turned on, so the instrument is designed to shield personnel from the radiation when the instrument is in use. A safety interlock is incorporated such that the synthetic radiation source will automatically turn off if the instrument is opened or in any way tampered with.

The invention uses solid-state measurement devices that use the principles of radiation based detection and has now introduced new technology to effectively produce the needed radiation without the use of radioactive sources. This new technology, termed synthetic beta, because its primary use will be to replace traditional beta gauges used extensively throughout industry, is essentially a new bread of miniature x-ray emitting technology that is completely electronically controlled. Electronic control means that the instrument is free from the regulations and safety concerns governing radioisotope sources, while at the same time delivering far superior performance.

This instrument is intended to be used for the purpose of measuring the basis weight, or by inference thickness, of materials placed in close proximity to the measurement surface. Backscatter type of radiation instruments have been use for many years in industry to measure a plethora of materials including thin polymer films and sheets, coatings, woven and non-woven textiles, paper, laminates, building products and many more.

Another very useful set of properties are gained when the solid-state detectors are employed in the pulse counting mode in conjunction with this new synthetic radiation source. Solid-state detectors can measure the energy of the x-ray or particle that they detect, unlike ionization chambers. Also, by proper choice of target material or intervening layers of selective absorbing materials, the energy spectrum output of the new synthetic source can be made to be nearly mono-energetic or have a narrow range of output energies, as opposed to producing a broad energy output spectrum. These factors can be used to a significant advantage and open up additional measurement applications in the following ways. First, the measurement can be even further stabilized, which is a critical factor in many measurement applications. Any means that improves the stabilization of a measurement is very important. When employed in on-line industrial measurement or control applications, the instrument's output is relied upon to reflect the weight, or other characteristic of the material being measured. If the instrument's output erroneously drifts unknowingly, then the production process would be adjusted in error and rejectable product would very likely be produced as a result of the instruments drift. This is a very serious problem and a gauge that exhibits this phenomena even to a very slight extent would be not useful and probably cause more harm than good. By employing detectors that are x-ray or particle energy responsive and narrowing up the emission of the synthetic radiation source, detection thresholds set around the known radiation energy levels can be employed. This makes the instrument much more immune to drifts in the detectors or their electronics, such as amplifiers, threshold circuits, nise floor shifts, and other causes of drift. Ion chambers, or broad band x-ray sources have no such advantage and any drift in either element or the electronics causes an undesired and unknown drift in the measurement.

Another advantage for the use of energy responsive detectors in conjunction with narrow band radiation produced by the synthetic radiation source is to preferentially select the fluorescence emission of certain substances within the material being measured. Every element emits a characteristic x-ray fluorescence spectrum that is used to identify the element and this property can be used to an advantage by setting the counting thresholds around these known energy levels to detect the presence of this particular element in the sample being measured. Applications of this technique would include the determination of the amount or percent ratio of the element zinc in various mixtures such as aluminum, or zinc and iron mixtures or coated on top of one another. These types of coatings are used often in the metals industries to, for instance, “galvanize” something, and the percentage of zinc, iron or aluminum either in mixture or coated upon one another is an important process parameter that must be controlled.

A further advantage of energy responsive detectors used in conjunction with the this new synthetic radiation source is when performing Compton backscatter measurements. Generally a nearly complete, or 180 degree backscatter geometry is created by having the synthetic radiation source emit a radiation beam through a shielded hole in the detector plane which impacts the material being measured. The Compton backscattered radiation that impinges the detectors have scattered through nearly 180 degrees, or has “backscattered”, under this geometry. The Compton effect shifts the energy of the Compton scattered radiation to a lower energy that is dependent upon the angle of the resultant scatter. Backscatter, or 180 degree Compton scattering produces the largest amount of energy downward shift. By setting detection thresholds around the known, predictable energy of the Compton backscattered radiation, preference over radiation from other sources can be obtained and improved measurements are the result. For instance, coherent, or Rayleigh scattering can occur that scatters the radiation back at the identical energy that it was emitted at, and this radiation can be rejected if desired. Interfering fluorescence can be rejected as well by setting detection thresholds around the known Compton downshifted radiation energy levels. This is useful for measuring paint or other polymer like coating on a substrate such as steel or other substrate that has a higher atomic number. Fluorescence emissions from the iron in the steel, the zinc in the galvanized coating or other impurities will be stimulated by the radiation impinging on these structures. The determination of the thickness of the paint or other coating is oftern dependent only on the amount of Compton backscatter from the paint, so being able to set detection thresholds around the known Compton backscattered radiation from the synthetic radiation source allows for the rejection of these other sources of radiation that will impinge the detector. In fact, with the use of multiple simultaneous detection thresholds, which are straight forward to implement with modern high speed microprocessor and solid-state circuitry, simultaneous measurements of the paint thickness, zinc thickness and substrate thickness may be made by forming counting channels centered at each of the respective radiation energy levels associated with each source of radiation.

Using these techniques, the measurement of a very small weight, such as paint, on top of a rather large weight of a substrate, such as steel plate or sheet as in automotive manufacturing, can be made very accurately by a single measurement from only one side of the material to be measured when backscatter geometry is employed. These are very important factors, since paint thickness or coating weight measurements are often attempted by first using a gauge to measure the weight of the uncoated substrate and then using a second gauge to measure the weight of the coated or painted substrate and then subtract the two measurements to yield paint thickness or weight. This has several practical limitations. First, two physically separate measurements must be made, most often when the object to measure is moving, such as on an assembly line. Therefore the precise point of each of two measurements must be determined and errors in this determination often cause large errors in the paint thickness calculations due to large differences in substrate weight from point to point and so forth. Second, since two measurements are involved, the error of each measurement is combined in the computation of the paint thickness, as opposed to only one measurement being involved in the new technique disclosed in this patent application. Lastly, the prior methods employing the differential techniques have severe limitations in many practical applications, such as paint thickness measurement in the automotive field, due to the large difference in the weight of the substrate, often galvanized steel, and the paint. When subtracted, the difference in a large number with a certain percent error from a much smaller number often yields a combined measurement error that is in excess of the weight or thickness of the paint itself. This often gives nearly a 100% error margin in the paint thickness computation, which is totally unacceptable.

Another application of the use of solid-state detectors with this new synthetic radiation source is the detection of concealed explosives, such as buried land mines or undersea mines that threaten ships or beach assaults. Mines do not contain much metal or have no metal at all and conventional techniques based on an electric induction signal are no longer effective. Undersea mines are now buried beneath the sea floor so that sonar cannot detect them. During the first Gulf war, the US Navy lost two ships, the Princeton and the Tripoli, due to undetected undersea mines. The Compton backscatter technique has been suggested by the Navy and others as a means by which these threats can be detected. The technology and techniques contained in this patent application give large advantages in detection of these threats over Compton backscatter implemented by prior art techniques. The material surrounding the mine, either soil for land mines, or seafloor sand or soil for undersea mines, has a larger average atomic number than does the high explosive material, which is largely comprised of nitrogen or chlorine. Therefore, photoelectric absorption will predominate over Compton backscatter in the sand or soil, since photoelectric absorption has a large dependence on the atomic number of the material, varying with the fourth or fifth power of the atomic number. The explosive material will have a strong preference to Compton backscatter, due to its lower atomic number and when a backscatter imaging system is employed to sweep over an area, the buries explosive will show up as a “bright spot” in contrast to its surroundings. This bright spot when detected with reference to the local background is very likely to be explosive material, since other materials of similar atomic number composition, such as Teflon, are not likely to be found in great quantities. By setting detection thresholds at the known Compton backscattered energy levels, this detection is optimized. An imaging system would employ, for example, a linear array of solid-state detectors and operate like a document scanner, as opposed to a generic backscatter gauge which would simple have solid-state detectors employed in a two dimensional array around the emitted radiation beam. A generic backscatter gauge would typically have all of its solid-state detector outputs combined into one grand measurement count, since all detectors in the array contain similar information. An imaging system could also employ a two dimensional array or matrix of individual solid-state detectors, but this would be somewhat rare for a while, since solid-state detectors are rather expensive. However, this could be employed to image small parts in other applications, where the total area of solid-state detectors are cost effective to employ in this manner.

The general techniques of explosive detection can also be employed in other useful applications. The detection or imaging of steel reinforcement rode in underwater structures is one example where effective means to perform this are needed, such as in bridge supports. The steel in a cement surrounding would behave similarly, except in this case the steel would show up as dark zones, since in this case the steel has a higher atomic number than the cement. Inspection and verification of location or position of small parts in boxes or containers, such as locating an object in an electronic enclosure, is another example of a useful application of the backscatter imaging technology. High volume manufacturing, food manufacturing, electronic product manufacturing, are examples of useful applications. The food industry has a need to detect foreign objects, such as metal shavings in pouches of food product as a consumer safety requirement. Detecting such objects inside sealed pouches of food at high production rates is a difficult problem, and the liability of someone choking on such an object is quite high. Such objects often inadvertently fall into food pouches during the production process from worn bearings, broken filter and screens, dropped or loosened screws and bolts, etc.

### BRIEF DESCRIPTION OF THE DRAWINGS

Various preferred embodiments of the present invention will be set forth in detail with reference to the drawings, in which:

FIGS. 1A and 1B show an instrument according to the first preferred embodiment;

FIG. 1C shows a microterminal usable with the instrument of FIGS. 1A and 1B;

FIGS. 1D and 1E show a modification of the instrument of FIGS. 1A and 1B;

FIGS. 2A-2D show a instrument according to the second preferred embodiment;

FIG. 3 shows an instrument according to the third preferred embodiment; and

FIG. 4 shows a radiation source usable in any of the preferred embodiments.

### DETAILED DESCRIPTION OF THE PREFERRED EMBODIMENTS

Preferred embodiments of the invention will be set forth in detail with reference to the drawings, in which like reference numerals refer to like elements throughout.

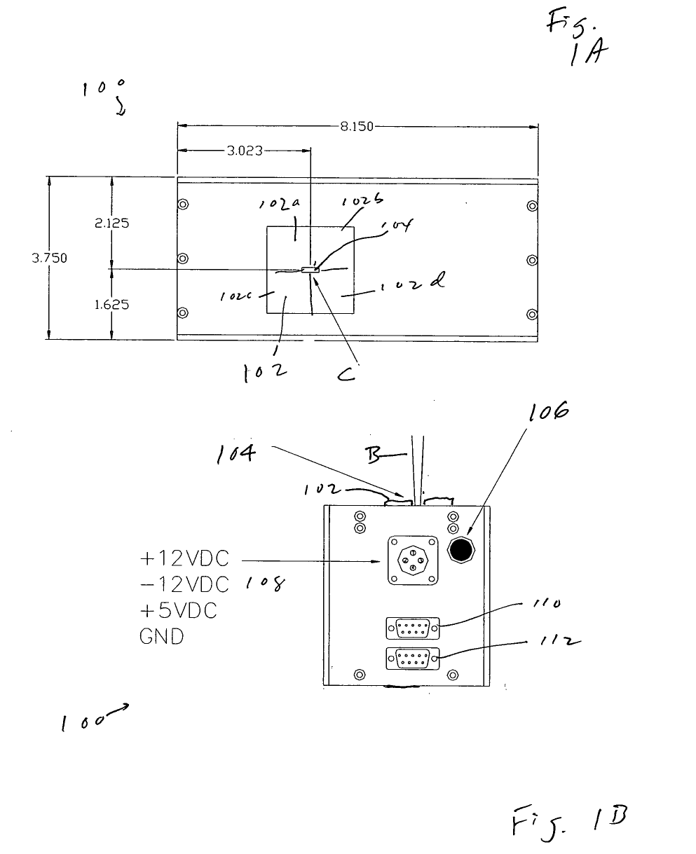

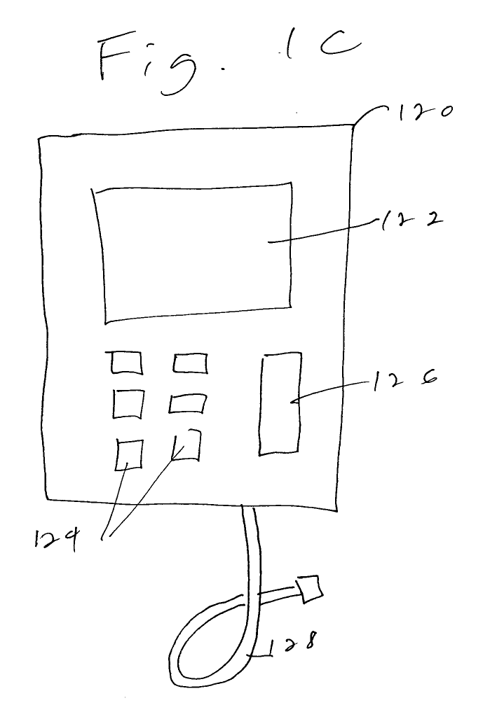

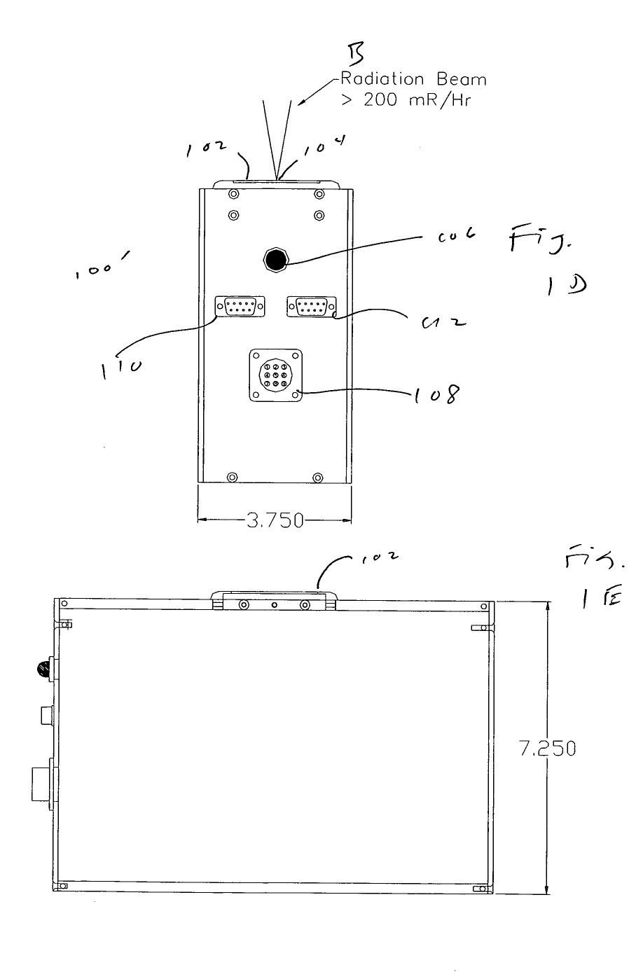

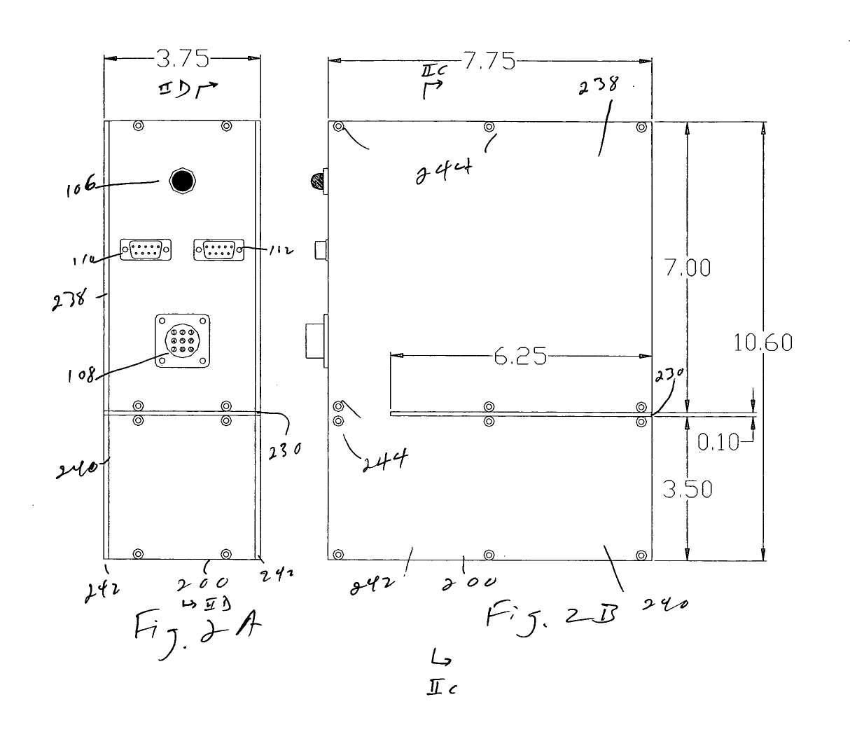

FIGS. 1A and 1B show a top view and a front view, respectively, of an instrument 100 according to the first preferred embodiment of the present invention. This instrument 100 uses the method of measurement termed “Compton Backscatter,” which permits a measurement to be made from only one side of the material to be measured.

The instrument 100 emits a beam B in the manner described above. The beam B includes a beam center C. The instrument also has a detector 102 configured as a four-part solid-state detector having four elements 102a, 102b, 102c, 102d so positioned as to define a hole 104 through which the beam B emerges. On the front of the instrument 100 are the following: a beam-on indicator light 106, a power socket 108 (+12 VDC, −12 VDC, +5 VDC, ground), a first DB-9 female connector 110 for connection to a microterminal, and a second DB-9 male connector 112 for serial communication.

The material to be measured is to be guided over the measurement spot defined by the beam center C. This measurement spot is at the center of the emitted radiation beam. The radiation beam interacts with the material in such a way that an amount of radiation is scattered back in the direction of the solid-state detectors 102a-102d that is proportional the basis weight of the material in the beam. The output of the four solid-state detectors 102a-102d is collected by the embedded microprocessor, and the total counts, or measurement in an engineering unit, is displayed on the device's microterminal. An analog output is also provided by means of a digital to analog converter that is controlled by the embedded microprocessor.

The material to be measured can either be slid over the surface of the instrument or the it can be supported by customer supplied rollers. If the material is held off of the surface, the amount of standoff should be kept to a minimum, approximately ¼″, and the degree of web movement or “flutter” should be minimized. Experimentation with the unit will allow ACT to determine the optimum operational parameters for its needs.

Control of the instrument is primarily through the microterminal unit connected to the port 110. Additionally, serial data can be extracted through a serial link provided by the port 112. The serial link uses the RS-232-C standard and employs a simple 3 wire interface at 9600 baud through an industry standard DB-9 male connector.

The main operator interface is the microterminal employing the use of function buttons and a scroll list of displays. As shown in FIG. 1C, the microterminal 120 includes a display 122 (which may be a touch-sensitive LCD or other inexpensive display), function keys or buttons 124, an “enter” key 126, and a serial cable 128 for connection to the instrument 100 via the port 110. Alternatively, the functions of the keys 124, 126 can be subsumed into the touch-sensitive display 122 in a manner known in the art, e.g., from personal digital assistants.

Pressing the upper left function key brings one to the top of the measure function scroll list and a banner appears. Pressing the Enter key will next display the current measurement in engineering units, such as grams per square meter, if the instrument has been setup and calibrated for this. The next display in the list is the total counts received by all four detectors. Since the primary purpose of the instrument is to collect detector counts, this will typically be the main display. Pressing the Enter key again will scroll through the individual counts received in the four detectors in this system.

The last display is the count interval in units of internal microprocessor timer clock rate. The internal microprocessor timer operates at a frequency of 28,800 pulses per second (3 times the baud rate of 9600 baud). If this display is set to 28,800, then the instrument is set up for a one-second count interval.

Pressing the lower left function button brings up the control function scroll list of displays. The display “HV Enable 0” is the important display to be aware of. This is where the x-ray beam is turned on or off by the person operating the instrument. Upon power up or reset, this parameter is set to 0, which indicates that the beam is turned off. Making this parameter a “1” turns the beam on, and the person operating the instrument must be aware that the x-ray production has started and must take the appropriate safety precautions.

If desired, the instrument may be calibrated in a desired engineering unit for direct conversion of the received counts into a measurement directly useful for engineering purposes. The upper right function button is the Calibrate Function scroll list. One has to first prepare a series of calibration standards, input their value and then present them sequentially to the instrument. The instrument can be made to accumulate the counts from each calibration standard and then form a two segment linear relation to convert the observed total counts into a measurement in engineering units.

Typically, the three calibration standards used are air or open beam, representing a zero value, followed by two other standards. The display titled Acquire is where the instrument takes the counts for a standard to compute the linear relation. The three standards are referred to as 0,1,2. To acquire the counts associated with the air or open beam, the user should make sure that the instrument has no material over the measurement spot and should then type 0 followed by Enter on the Acquire screen. Similarly, the user should place the smaller of the two calibration standards on the measurement spot and type 1 followed by Enter to acquire the counts for the second calibration standard and do the same for the other calibration standard.

On the following screens, the user inputs the actual engineering values of the three standards to give the instrument all of the information needed to create the linear curve. Finally, the user goes to the Recipe Function, the middle left function button, to permanently save the calibration settings and all other setup parameters to be saved. Otherwise, this information will be lost when the instrument is turned off or reset.

The male DB-9 connector 112 on the front of the instrument is for the serial communications link. This link allows data to be obtained from the instrument by, for instance, a personal computer, for automated processing of the information generated by the instrument. The communication interface and protocol is very similar to other instruments developed by PAT.

The interface is a simple 3 wire RS-232-C interface, with no handshaking signals employed. Pin 2 is the transmit out from the instrument and Pin 3 is the receive into the instrument and Pin 5 is the signal common. The baud rate is fixed at 9600 baud and the character length is 8 bits with one start, one stop, and no parity bit.

The software protocol is a simple ASCII based character command mode of operation. The instrument only responds to defined commands, which are simply defined as a single upper case ASCII letter followed by an ASCII carriage return character.

When the instrument receives the ASCII upper case C followed by a carriage return, this is the total count command. The instrument responds with a stream of up to eight decimal coded ASCII characters representing the current value of the total counts received from both detectors, followed by the carriage return character.

The receipt of the upper case W followed by a carriage return is the weight command and the instrument responds with a stream of ASCII coded decimal characters representing the current measurement in the unit the the instrument was calibrated. The format is fixed point in F5.3 format, followed by a carriage return character.

The receipt of the upper case D followed by the carriage return character is the data command, and the instrument returns the current value of the four individual counter values separated by an ASCII TAB character. This command may be used to diagnose the operation of individual counters.

The microterminal may be used as an aid to diagnose communication problems. The middle right function key is the Measure Test function and this function provides a scroll list of displays that show the last received command, the number of characters and valid commands received and permits the sending of a test message under operator control.

An analog output is provided for systems that prefer to use this method of interfacing to external devices or meters, etc. Since this instrument works intrinsically in a digital fashion, the analog output is generated by use of a digital to analog converter (DAC). The analog output is updated at the end of every measurement cycle and the circuitry provides no filtering so that there will be no slowing down of the speed of response. The analog range of the output is ±10V and the voltage is driven by an LT1057 operational amplifier for driving any cables that may be between the instrument and the ultimate destination of the signal.

Software in the embedded microprocessor computes the digital word that is sent to the DAC for conversion into analog form at the end of every measurement cycle. The embedded software uses the instrument's measurement in engineering units as the starting point for this computation. Therefore, the instrument must be calibrated for some basis weight scale before this analog output can be used properly. The output of the measurement in the calibrated engineering units, which are displayed on the microterminal as explained above, are interpreted without the decimal point. In other words, if 15.43 is displayed, the software interprets this as an integer with a value of 1543. This integer is next multiplied by 1000 and then divided by the DAC Conversion word, which is input through the microterminal by the operator and stored in nonvolatile memory with the recipe. The result of this computation is the digital integer that is sent to the DAC for conversion into analog format.

The reason for choosing this approach is to allow the user a greater amount of flexibility in generating the desired analog voltage output for a particular application. If the instrument is calibrated, then negative measurements in engineering units generate negative voltages. The magnitude of the voltage can be changed, or scaled, by modifying the DAC Conversion word, or by altering the calibration of the instrument in the calibration procedure. Regions of interest, offset values, or magnification factors can be implemented to give the analog output desired to see the features that the user desires by adjusting these parameters appropriately. The instrument is merely a calculator connected to a set of four sensors that is programmed to process the information as described in this document. The various parameters can be modified as needed to generate the desired output, even if the physical interpretation of the settings is not considered.

The parameters associated with the analog output are accessed through the microterminal by pressing the middle right function button, and scrolling down in the usual manner to see the parameter desired. In this diagnostic function list also appears displays of commands and character counts, etc. that are useful in debugging the RS-232-C communication link.

Of course, the dimensions of the instrument can be varied to accommodate the needs of existing equipment or the like. For example, a modified instrument 100′ is shown in FIGS. 1D and 1E.

A second preferred embodiment will now be disclosed. The second preferred embodiment is capable of measuring the banded paper in conjunction with wind/unwind machinery. The instrument will only need to measure the paper near the edge of the paper, as opposed to in the middle of the web or across the web. The speed of the measurement shall be sufficient for measuring the bands at a rate that would allow a roll of paper to be measured in a reasonable period of time.

Cigarette paper is rather light as compared to typical web process measurements, being typically in the 25 GSM range. Bands of starch-like material are then applied to the paper in a printing process, such as a Gravure Coater. The bands are approximately 6 millimeters wide in the machine direction and are separated a few millimeters so that a typical cigarette contains three bands. The target weight of the bands is 5% of the nominal basis weight of the paper and the acceptable range in this weight is ±1%.

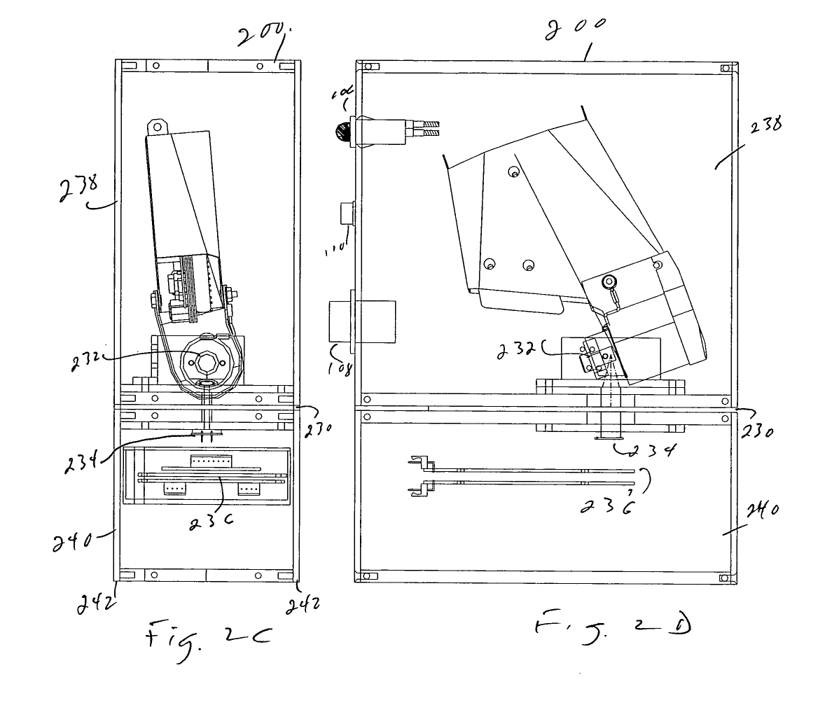

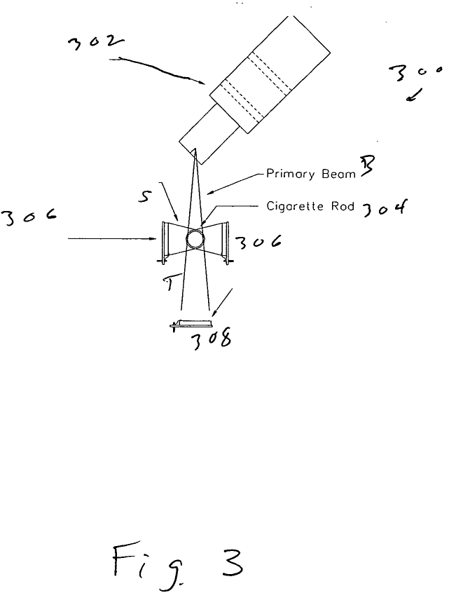

The instrument 200 according to the second preferred embodiment of the present invention is shown in external views in FIGS. 2A and 2B. A cross-sectional view along the lines IIC-IIC of FIG. 2B is shown in FIG. 2C, while a cross-sectional view along the lines IID-IID of FIG. 2A is shown in FIG. 2D.

As shown in FIGS. 2A-2D, the instrument 200 includes a slot 230 through which the paper passes. The instrument also includes a source 232 of radiation, a four-part solid-state detector 234, and circuitry 236. Otherwise, the instrument 200 can be configured like the instrument 100 or 100′ of the first preferred embodiment.

The instrument 200 is designed to permit measuring the bands on the paper from one edge of the web at a point approximately 4 inches in from the edge. The measurement spot will be approximately 10 millimeters by 2 millimeters. The instrument has mounting provisions so that the user can securely mount and align the head for proper measurement.

The instrument can measure the basis weight of the web with a nominal basis weight of 25 GSM to a precision of ±1% at two standard deviations. This has to be done at a response time of 50 milliseconds in order to reliably determine that each band is within the acceptable range to comply with government regulations.

The measurement will be made in transmission mode, where the radiation passes through the material to be measured, in order to achieve the response time requirements. The measurement geometry will be controlled as tightly as possible to maximize the signal strength and reduce the deleterious effects of web flutter, misalignment and air gap temperature drifts.

The instrument is formed as a top unit 238 which houses the synthetic radiation source 232 and a lower unit 240 that houses the detector element 234 and the electronic circuit cards 236. These two units 238, 240 will be fashioned into a single unit through the use of two side plates 242 that hold them together and create the pass gap for the material to be measured. The general construction method will be to machine the parts from ¼″ aluminum plate and assemble the parts with 6-32 or 4-40 screws 244.

The light 106, power socket 108 and ports 110, 112 can be like those of the first preferred embodiment. Power requirement will be +15 VDC, −15 VDC and +5 VDC. The +15 VDC will be required to supply up to 4 watts of power, the +5 VDC will require less than one watt and the −15 VDC will require less than 0.1 watt of power. The instrument is powered from 120 VAC “wall outlet” power source.

In order to achieve the measurement performance needed, the synthetic radiation source shall be operated at a rather low value of applied high voltage, probably in the vicinity of 5,000 Volts. This is chosen to make the output radiation as “soft” as possible so that a large absorption effect is realized when the paper is presented to the radiation beam. A transmission mode measurement uses the change in absorption as the basis for its measurement. This presents an interesting paradox. A large percent absorption is desired in the first place so that small changes are seen in the degree of absorption when small changes in the paper basis weight occur. However, a large absorption decreases the detected signal at the detector and this causes the signal to noise ratio and detector response time to drastically reduce.

The synthetic radiation source technology has the ability to allow its high voltage to be continually adjusted to 32 kilovolts, but 5 kilovolts is at the low end of its range, where potential instabilities may arise. The current output of the synthetic radiation source will be maximized to overcome the significantly lowered signal at the detector that results from the lowered high voltage on the unit.

The solid-state detectors are a compound, wide bandgap, semiconductor of CdZnTe with detection area of 10 millimeters by 10 millimeters and a thickness of 2 millimeters. This gives a good detection spot size and more than sufficient thickness to stop all of the radiation impinging on the detectors to yield a very high efficiency for detecting this radiation. With a large radiation flux incident on the detectors, the gain of the amplifier circuitry, and the detector bias voltage, can be chosen so as to minimize the leakage current contributions to the output signal. Nonetheless, leakage current is expected to play a significant role in diminishing this measurement and some signal conditioning and signal processing techniques will be needed to offset this.

The synthetic source has a unique ability to rapidly turn on and off, or continually modulate, its output radiation power through the control of the tube's beam current. This ability is made possible because the beam current is created by field emission from carbon nanotubes, as opposed to a heated filament in conventional x-ray generating equipment. This ability to modulate the radiation output will be use to an advantage through the use of phase-locked detection methodology. Phase locked detection is used extensively in other fields, such as radar and sonar, and is known to give many orders of magnitude increases in signal to noise ratio of a measurement. The necessary feature for this type of detection is the establishment of a “signature” of known timing or phase on the signal to be measured that allows the electronic circuits to preferentially detect and amplify this signal and reject all others. This new synthetic radiation source is the only known technology for the generation of ionizing radiation that has this capability.

A third preferred embodiment will be disclosed for measuring the weight of cigarette rods. The third preferred embodiment can be constructed and controlled like the first and second preferred embodiments, except for the differences to be described.

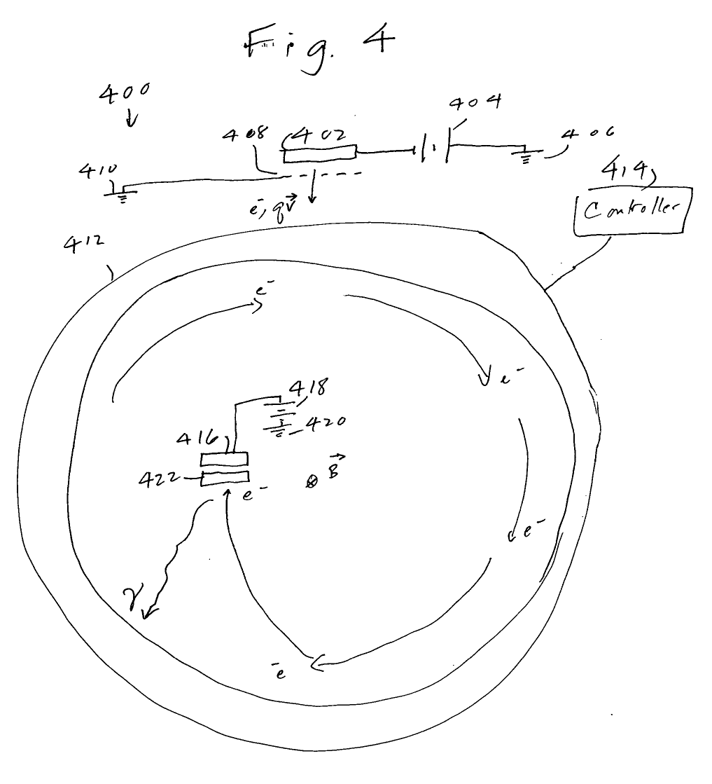

As shown in FIG. 3, the instrument 300 according to the third preferred embodiment includes a synthetic radiation source 302. The output strength is more than one curie when on and is completely absent when off.

A holder holds the rod 304 in the path of the beam B from the source 302. The beam B yields two side-scattered beams S and a transmitted beam T.

The side-scattered beams S are detected by detectors 306. The transmitted beam T is detected by a detector 308.

Each of the detectors 306, 308 is a solid-state detector of high efficiency (˜100%) and can operate in digital and analog modes. Each of the two modes, digital and analog, has advantages and disadvantages. The digital mode has high stability and insensitivity to composition, but is limited in response time. The analog mode has a fast response time but is slightly composition sensitive and has an analog drift that can be compensated by the digital mode. In operation, the digital mode compensates the analog mode, which is used for response time.

A source usable in any of the preferred embodiments is shown in FIG. 4. In the source 400, a carbon nanotube cathode 402 is connected to a power supply 404, which is connected to ground 406. In front of the cathode 402 is a mesh 408, which is connected to ground 410. Electrons are emitted by the cathode 402 and accelerated by an electric field between the cathode 402 and the mesh 408 to have a velocity v and thus a charge-velocity product qv.

Magnetic field coils 412 under the control of a controller 414 generate a magnetic field B. As explained above, the electrons passing through the magnetic field B experience a Lorentz force qv×B which causes them to move in an orbit. When B is increased, as described above, the electrons move with increased energy and are caused to be incident on a target 416, which is connected through a power source 418 to ground 420. The collision between the electrons and the target causes the target to emit x-rays. Either the target 416 or an optional intermediate attenuating body 422 can be selected to cause the x-rays to be emitted only in a narrow energy band for the purposes described above.

While various preferred embodiments of the present invention have been set forth in detail, those skilled in the art who have reviewed the present disclosure will readily appreciate that other embodiments can be realized within the scope of the invention. For example, numerical values are illustrative rather than limiting. Also, features taught as being used in one of the embodiments, such as sensor design, can be used in another of the embodiments. Therefore, the present invention should be construed as limited only by the appended claims.

1. An instrument for performing measurement on an object, the instrument comprising:
a radiation source for generating a beam of radiation, the radiation source comprising (i) a cold cathode, comprising a carbon nanotube material, for emitting electrons and (ii) a target, in a path of the electrons emitted by the cold cathode, for emitting the beam of radiation when struck by the electrons; and
a solid state detector, disposed to intercept the beam of radiation after the beam of radiation has been made incident on the object, for detecting the beam of radiation and for outputting a signal representing the beam of radiation.

2. The instrument of claim 1, further comprising a computing device for receiving the signal and for calculating and outputting, in accordance with the signal, a numerical value representing a property of the object.

3. The instrument of claim 2, wherein the property comprises thickness.

4. The instrument of claim 2, wherein the property comprises mass per unit area.

5. The instrument of claim 2, wherein the computing device is connected to the radiation source to control the radiation source and is programmed to modulate the beam of radiation.

6. The instrument of claim 5, wherein the computing device is programmed to modulate the beam of radiation and to analyze the signal, to achieve phase-locked detection.

7. The instrument of claim 6, wherein the beam of radiation comprises soft x-rays.

8. The instrument of claim 5, wherein the computing device is programmed (i) to modulate the beam of radiation by turning the beam of radiation off and then on while the instrument operates, (ii) to determine, from the signal received while the beam of radiation is off, a leakage current of the detector, and (iii) to calibrate the detector in accordance with the leakage current.

9. The instrument of claim 1, wherein the radiation source and the detector are positioned relative to each other such that the detector receives the beam of radiation after the beam of radiation has been transmitted through the object.

10. The instrument of claim 1, wherein the radiation source and the detector are positioned relative to each other such that the detector receives the beam of radiation after the beam of radiation has been backscattered from the object.

11. The instrument of claim 1, wherein the radiation source and the detector are positioned relative to each other such that the detector receives the beam of radiation after the beam of radiation has been side-scattered from the object.

12. The instrument of claim 1, wherein the detector comprises:
a first detector which is positioned relative to the radiation source such that the first detector receives a first portion of the beam of radiation after the first portion of the beam of radiation has been transmitted through the object; and
a second detector which is positioned relative to the radiation source such that the second detector receives a second portion of the beam of radiation after the second portion of the beam of radiation has been side-scattered through the object.

13. An instrument for performing measurement on an object, the instrument comprising:
a radiation source for generating a beam of radiation, the radiation source comprising (i) a cold cathode, comprising a carbon nanotube material, for emitting electrons and (ii) a target, in a path of the electrons emitted by the cold cathode, for emitting the beam of radiation when struck by the electrons;
a detector, disposed to intercept the beam of radiation after the beam of radiation has been made incident on the object, for detecting the beam of radiation and for outputting a signal representing the beam of radiation; and
a computing device for receiving the signal and for calculating and outputting, in accordance with the signal, a numerical value representing a property of the object, wherein the computing device is connected to the radiation source to control the radiation source and is programmed to modulate the beam of radiation.

14. The instrument of claim 13, wherein the computing device is programmed to modulate the beam of radiation and to analyze the signal, to achieve phase-locked detection.

15. The instrument of claim 14, wherein the beam of radiation comprises soft x-rays.

16. The instrument of claim 13, wherein the radiation source and the detector are positioned relative to each other such that the detector receives the beam of radiation after the beam of radiation has been transmitted through the object.

17. The instrument of claim 13, wherein the radiation source and the detector are positioned relative to each other such that the detector receives the beam of radiation after the beam of radiation has been backscattered from the object.

18. The instrument of claim 13, wherein the radiation source and the detector are positioned relative to each other such that the detector receives the beam of radiation after the beam of radiation has been side-scattered from the object.

19. The instrument of claim 13, wherein the detector comprises:
a first detector which is positioned relative to the radiation source such that the first detector receives a first portion of the beam of radiation after the first portion of the beam of radiation has been transmitted through the object; and
a second detector which is positioned relative to the radiation source such that the second detector receives a second portion of the beam of radiation after the second portion of the beam of radiation has been side-scattered through the object.

20. An instrument for performing measurement on a sheet of material, the instrument comprising:
a radiation source for generating a beam of radiation, the radiation source comprising (i) a cold cathode, comprising a carbon nanotube material, for emitting electrons and (ii) a target, in a path of the electrons emitted by the cold cathode, for emitting the beam of radiation when struck by the electrons;
a roller assembly for moving the sheet of material such that the beam of radiation is incident on the sheet of material and such that the sheet of material moves past the source; and
a detector, disposed to intercept the beam of radiation after the beam of radiation has been made incident on the sheet of material, for detecting the beam of radiation and for outputting a signal representing the beam of radiation.

21. The instrument of claim 20, wherein the source and the detector are disposed to be on opposite sides of the sheet of material, such that the beam of radiation is transmitted through the sheet of material.

22. The instrument of claim 21, further comprising a computing device for receiving the signal and for calculating and outputting, in accordance with the signal, a numerical value representing a property of the object.

23. The instrument of claim 22, wherein the property comprises thickness.

24. The instrument of claim 22, wherein the property comprises mass per unit area.

25. The instrument of claim 20, wherein the computing device is connected to the radiation source to control the radiation source and is programmed to modulate the beam of radiation.

26. The instrument of claim 25, wherein the computing device is programmed to modulate the beam of radiation and to analyze the signal, to achieve phase-locked detection.

27. The instrument of claim 26, wherein the beam of radiation comprises soft x-rays.

28. The instrument of claim 22, wherein the detector is a solid state detector.

29. The instrument of claim 28, wherein the computing device is programmed (i) to modulate the beam of radiation by turning the beam of radiation off and then on while the instrument operates, (ii) to determine, from the signal received while the beam of radiation is off, a leakage current of the detector, and (iii) to calibrate the detector in accordance with the leakage current.

30. An instrument for performing measurement on a rod-shaped object, the instrument comprising:
a radiation source for generating a beam of radiation, the radiation source comprising (i) a cold cathode, comprising a carbon nanotube material, for emitting electrons and (ii) a target, in a path of the electrons emitted by the cold cathode, for emitting the beam of radiation when struck by the electrons;
a holder for holding the rod-shaped object in a path of the beam of radiation; and
a detector, disposed to intercept the beam of radiation after the beam of radiation has been made incident on the object, for detecting the beam of radiation and for outputting a signal representing the beam of radiation.

31. The instrument of claim 30, wherein the detector comprises:
a first detector which is positioned relative to the radiation source such that the first detector receives a first portion of the beam of radiation after the first portion of the beam of radiation has been transmitted through the object; and
a second detector which is positioned relative to the radiation source such that the second detector receives a second portion of the beam of radiation after the second portion of the beam of radiation has been side-scattered through the object.

32. The instrument of claim 31, wherein each of the first detector and the second detector is a solid state detector.

33. A method for performing measurement on an object, the method comprising:
(a) generating a beam of radiation by emitting electrons from a carbon nanotube material, causing the electrons to be incident on a target and emitting the beam of radiation from the target;
(b) causing the beam of radiation to be incident on the object;
(c) detecting the beam of radiation using a solid state detector and outputting a signal; and
(d) performing the measurement on the object in accordance with the signal to determine a property of the object.

34. The method of claim 33, wherein the property comprises thickness.

35. The method of claim 33, wherein the property comprises mass per unit area.

36. The method of claim 2, wherein step (a) comprises modulating the beam of radiation.

37. The method of claim 36, wherein step (a) comprises modulating the beam of radiation and analyzing the signal, to achieve phase-locked detection.

38. The method of claim 37, wherein the beam of radiation comprises soft x-rays.

39. The method of claim 36, wherein step (a) comprises modulating the beam of radiation by turning the beam of radiation off and then on while the instrument operates, determining, from the signal received while the beam of radiation is off, a leakage current of the detector, and calibrating the detector in accordance with the leakage current.

40. The method of claim 33, wherein step (c) comprises receiving the beam of radiation after the beam of radiation has been transmitted through the object.

41. The method of claim 33, wherein step (c) comprises receiving the beam of radiation after the beam of radiation has been backscattered from the object.

42. The method of claim 33, wherein step (c) comprises receiving the beam of radiation after the beam of radiation has been side-scattered from the object.

43. The method of claim 33, wherein step (c) comprises:
receiving a first portion of the beam of radiation after the first portion of the beam of radiation has been transmitted through the object; and
receiving a second portion of the beam of radiation after the second portion of the beam of radiation has been side-scattered through the object.

44. The method of claim 33, wherein the object comprises a sheet material.

45. The method of claim 44, wherein the sheet material comprises paper.

46. The method of claim 45, wherein the paper is cigarette paper.

47. The method of claim 33, wherein the object comprises a rod.

48. The method of claim 47, wherein the rod is a cigarette rod.

49. A method for performing measurement on an object, the method comprising:
(a) generating a beam of radiation by emitting electrons from a carbon nanotube material, causing the electrons to be incident on a target and emitting the beam of radiation from the target;
(b) causing the beam of radiation to be incident on the object;
(c) detecting the beam of radiation and outputting a signal representing the beam of radiation; and
(d) receiving the signal and for calculating and outputting, in accordance with the signal, a numerical value representing a property of the object;
wherein step (a) comprises modulating the beam of radiation.

50. The method of claim 49, wherein step (a) comprises modulating the beam of radiation and analyzing the signal, to achieve phase-locked detection.

51. The method of claim 50, wherein the beam of radiation comprises soft x-rays.

52. The method of claim 49, wherein step (c) comprises receiving the beam of radiation after the beam of radiation has been transmitted through the object.

53. The method of claim 49, wherein step (c) comprises receiving the beam of radiation after the beam of radiation has been backscattered from the object.

54. The method of claim 49, wherein step (c) comprises receiving the beam of radiation after the beam of radiation has been side-scattered from the object.

55. The method of claim 49, wherein step (c) comprises:
receiving a first portion of the beam of radiation after the first portion of the beam of radiation has been transmitted through the object; and
receiving a second portion of the beam of radiation after the second portion of the beam of radiation has been side-scattered through the object.

56. The method of claim 49, wherein the object comprises a sheet material.

57. The method of claim 56, wherein the sheet material comprises paper.

58. The method of claim 57, wherein the paper is cigarette paper.

59. The method of claim 49, wherein the object comprises a rod.

60. The method of claim 59, wherein the rod is a cigarette rod.

61. A method for performing measurement on a sheet of material, the method comprising:
(a) generating a beam of radiation by emitting electrons from a carbon nanotube material, causing the electrons to be incident on a target and emitting the beam of radiation from the target;
(b) moving the sheet of material such that the beam of radiation is incident on the sheet of material and such that the sheet of material moves past the target;
(c) detecting the beam of radiation and outputting a signal representing the beam of radiation; and
(d) receiving the signal and calculating and outputting, in accordance with the signal, a numerical value representing a property of the sheet of material.

62. The method of claim 61, wherein step (c) comprises detecting the beam of radiation after the beam of radiation is transmitted through the sheet of material.

64. The method of claim 61, wherein the property comprises thickness.

65. The method of claim 61, wherein the property comprises mass per unit area.

66. The method of claim 61, wherein step (a) comprises modulating the beam of radiation.

67. The method of claim 66, wherein step (a) comprises modulating the beam of radiation and analyzing the signal, to achieve phase-locked detection.

68. The method of claim 67, wherein the beam of radiation comprises soft x-rays.

69. The method of claim 61, wherein step (c) is performed using a solid state detector.

70. The method of claim 69, wherein step (a) comprises (i) modulating the beam of radiation by turning the beam of radiation off and then on while the instrument operates, (ii) determining, from the signal received while the beam of radiation is off, a leakage current of the detector, and (iii) calibrating the detector in accordance with the leakage current.

71. The method of claim 69, wherein the sheet of material comprises paper.

72. The method of claim 71, wherein the paper is cigarette paper.

73. A method for performing measurement on a rod-shaped object, the method comprising:
(a) generating a beam of radiation by emitting electrons from a carbon nanotube material, causing the electrons to be incident on a target and emitting the beam of radiation from the target;
(b) holding the rod-shaped object in a path of the beam of radiation;
(c) detecting the beam of radiation and outputting a signal representing the beam of radiation; and
(d) determining, from the signal, a property of the rod-shaped object.

74. The method of claim 73, wherein step (c) comprises:
detecting a first portion of the beam of radiation by using a first detector after the first portion of the beam of radiation has been transmitted through the object; and
detecting a second portion of the beam of radiation by using a second detector after the second portion of the beam of radiation has been side-scattered through the object.

75. The method of claim 74, wherein each of the first detector and the second detector is a solid state detector.

76. The method of claim 73, wherein the rod-shaped object is a cigarette rod.

77. A method for emitting a high-voltage electron beam, the method comprising:
(a) emitting electrons from a carbon nanotube cathode; and
(b) accelerating the electrons through magnetic induction to form the high-voltage electron beam.

78. The method of claim 77, wherein step (b) comprises:
(i) causing the electrons to enter a region of a magnetic field; and
(ii) increasing the magnetic field to cause the electrons to gain energy.

79. A device for emitting a high-voltage electron beam, the device comprising:
a carbon nanotube cathode for emitting electrons; and
a magnetic field applying device for applying a magnetic field to the electrons to accelerate the electrons through magnetic induction to form the high-voltage electron beam.

80. The device of claim 79, wherein the magnetic field applying device comprises a controller for increasing the magnetic field to cause the electrons to gain energy.

81. A method for emitting a beam of radiation, the method comprising:
(a) emitting electrons from a cathode comprising a carbon nanotube material; and
(b) causing the electrons to be incident on a target for emitting the beam of radiation when struck by the electrons;
wherein the target or an intervening layer is selected to narrow a range of output energies of the beam of radiation.

82. The method of claim 81, wherein the beam of radiation is made incident on an object to make a stabilized measurement of a characteristic of the object.

83. The method of claim 81, wherein the beam of radiation is made incident on an object, and wherein the range of output energies is selected to select a fluorescence emission of a material in the object.

84. The method of claim 81, wherein the beam of radiation is made incident on an object, backscattered radiation from the object is detected and the range of output energies is used to distinguish the backscattered radiation from spurious radiation.

85. The method of claim 84, wherein the object comprises a substrate with a coating on the substrate, and wherein the backscattered radiation from the object is detected to measure the coating.

86. The method of claim 85, wherein the coating comprises paint.

87. A method for detection of an object comprising a first material and concealed in a second material, the method comprising:
(a) generating a beam of radiation by emitting electrons from a carbon nanotube material, causing the electrons to be incident on a target and emitting the beam of radiation from the target;
(b) causing the beam of radiation to be incident on the object to generate Compton backscattered radiation;
(c) detecting the Compton backscattered radiation using a solid state detector and outputting a signal; and
(d) detecting the object in accordance with the signal.

88. The method of claim 87, wherein step (d) is performed in accordance with differences in atomic weights between the first material and the second material.

89. The method of claim 88, wherein the first material comprises an explosive material.

90. The method of claim 89, wherein the second material comprises soil.

91. The method of claim 89, wherein the second material comprises a sea bed.

92. The method of claim 88, wherein the first material comprises metal.

93. The method of claim 92, wherein the second material comprises cement.

94. The method of claim 93, wherein the object is a reinforcing rod in a cement structure.

95. The method of claim 92, wherein the object is a metal shaving in a food product.
